(19) United States
(12) Patent Application Publication
(10) Pub. No.: US 2025/0214247 A1
(43) Pub. Date: Jul. 3, 2025

(54) Iterative Robot-Vision Calibration

(71) Applicant: Bright Machines, Inc., San Francisco, CA (US)

(72) Inventors: Ali Shafiekhani, San Francisco, CA (US); Vishwajeet Padmanabh Karmarkar, Atlanta, GA (US); Barrett Christopher Clark, Atlanta, GA (US); Emmanuel Gallo, Oakland, CA (US); Murali Pappoppula, Fremont, CA (US)

(21) Appl. No.: 19/001,385

(22) Filed: Dec. 24, 2024

Related U.S. Application Data
(60) Provisional application No. 63/615,220, filed on Dec. 27, 2023.

(51) Int. Cl. B25J 9/16; B25J 19/02

(52) U.S. Cl. CPC B25J 9/1692; B25J 19/023

(57) ABSTRACT

A method of calibrating a robotic arm which includes perform iterative eye-in-hand and robot calibration, using a calibrated end of arm camera with known intrinsic parameters and a static target, to obtain eye-in-hand transformations and robotic parameters. The method further uses robotic parameters to estimate pose of end of arm, for eye-to-hand calibration, to obtain eye-to-hand transformations and calculates final error compensation based on the robotic parameters, eye-to-hand transformations, and eye-in-hand transformations. In one embodiment, the method calculates a robot positioning error map function, the robot positioning error map function used to adjust movement parameters for the robotic arm.

### RELATED CASES

The present application claims priority to U.S. Provisional Application No. 63/615,220, filed on Dec. 27, 2023, and incorporates that application in its entirety.

### FIELD

The present invention relates to robotic systems, and more particularly to calibration of robotic systems.

### BACKGROUND

Robotic manipulators are known for high precision (repeatability) however, their accuracy can be compromised without regular and expensive maintenance and calibration procedures. Using robotic arms in an industrial setup with high volume of operations can gradually reduce the accuracy, and a reduction of accuracy of even a few hundred microns can cause the operations to fail. Also, in a vision guided setup the error from a robot could potentially interfere with vision calibration, which directly causes an error in positioning the object in robot frame.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 is a block diagram of one embodiment of the iterative calibration system.

FIG. 2 is a diagram of one embodiment of a robotic arm, showing the coordinate frames.

FIGS. 3A and 3B are exemplary images of the robotic arm and the fiduciaries which may be used for calibration.

FIG. 4 is an overview flowchart of one embodiment of the use of the iterative calibration system.

FIG. 5 is a flowchart of one embodiment of the iterative calibration system.

FIG. 6 is a block diagram of a computer system that may be used with the present invention.

### DETAILED DESCRIPTION

The present system is designed to improve the calibration of a robotic cell. The iterative calibration system is designed to iteratively adjust robot kinematic parameters while correcting hand-eye transformations using low-cost in-process 2D sensing devices. The process uses the data from existing sensors inside a robotic cell as well as the robot's joint angles. The data is registered in robot coordinate frame to estimate robot kinematic parameters while robot kinematic parameters are used for the registration, and the iterative approach solves for both registration and robot kinematic parameters. This enables the robot to move more accurately in assembling systems, disassembling systems, or other actions.

In one embodiment, the sensing devices are 2D cameras, which include stereo cameras at the top of the robotic cell, as well as an end of arm camera. These sensing devices, in one embodiment, are part of the configuration of the robotic cell in use. Thus, the iterative calibration process does not require the addition of special components. Furthermore, this iterative calibration may be done at the initialization of the system, and periodically while the system is in use. In one embodiment, after initialization the calibration is periodically validated. The validation may be triggered by time, for example at the beginning of each shift, once a day, once a week, etc. The validation may also be triggered by changes to the use of the robotic cell, e.g., when a new assembly process is started, or after a certain number of components have been inserted. The validation may also be automatically triggered by a detected event, such as a bumping of the robotic cell by an external force, moving or repositioning the robotic cell, or a user triggering validation.

The following detailed description of embodiments of the invention make reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized, and that logical, mechanical, electrical, functional, and other changes may be made without departing from the scope of the present invention. The following detailed description is, therefore, not to be taken in a limiting sense, and the scope of the present invention is defined only by the appended claims.

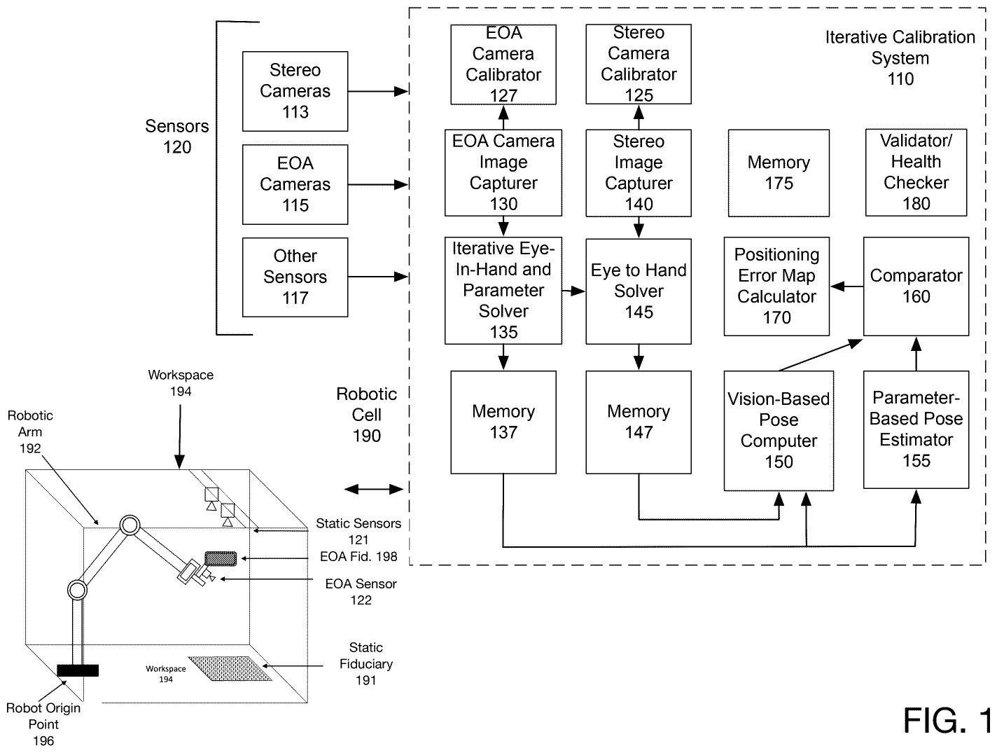

FIG. 1 is a block diagram of one embodiment of the iterative calibration system. The iterative calibration system 110 receives data from a robotic cell 190, including one or more sensors 120, which may include stereo cameras 113, end of arm (EOA) cameras 115, and/or other sensors 117. The sensors 120 may include static sensors 121 coupled to a stable point on a robotic cell frame, and end of arm sensors 122 coupled to the end of arm of a robotic arm 192.

The iterative calibration system 110 in one embodiment captures images with an end of arm camera 115, using end of arm camera image capturer 130, and from the stereo cameras 113, via stereo image capturer 140. In one embodiment, data captured by another type of sensor, such as a structured light sensor is considered image data. For simplicity the below description references cameras and images, however, data from other types of sensors may be used. For example, instead of cameras, depth sensors and other 2D or 3D sensors, inferometers, or other types of sensors can be used.

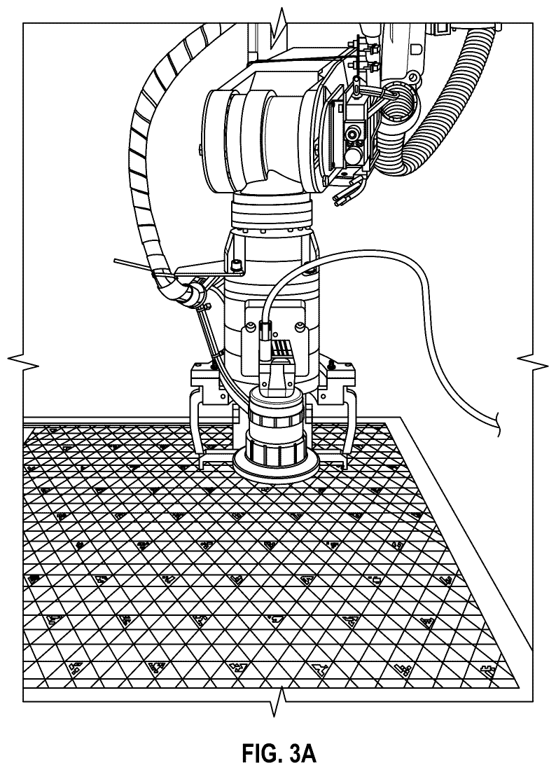

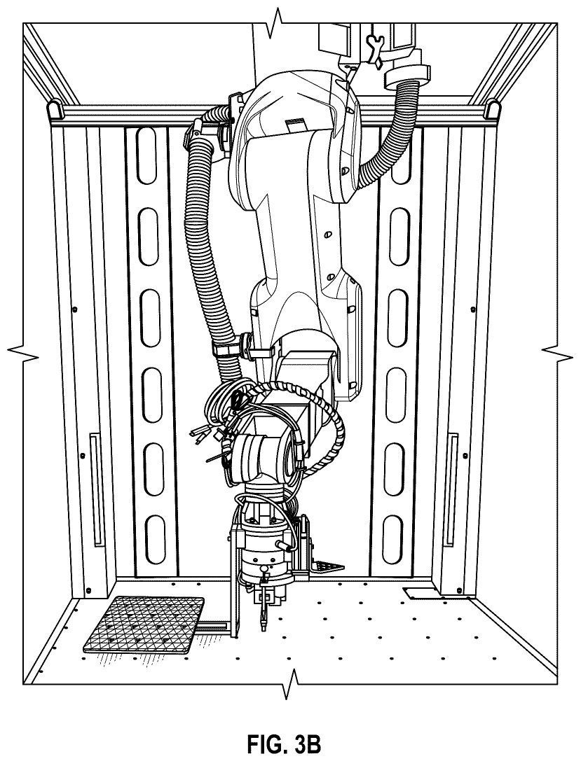

In one embodiment, the end of arm camera image capturer 130 takes images of the static fiduciary 191, or static calibration board, which is part of the workspace 194. In one embodiment, the static fiduciary 191 covers most of the workspace area, as shown in FIG. 3A. In another embodiment, patterns on the workspace may be used, rather than the fiduciary pattern shown. The end of arm image capturer 130 in one embodiment takes a series of images with the robotic arm 192 in different poses.

In one embodiment, the stereo cameras 130 capture images of the end of arm fiduciary 198, or calibration board, attached to the end of arm. An exemplary illustration of the end of arm fiduciary is shown in FIG. 3B. The stereo image capture 140 in one embodiment takes a series of images with the end of arm fiduciary 198 in different locations.

The stereo camera calibrator 125 uses the captured stereo images to calibrate the stereo cameras 113 for intrinsic parameters. The intrinsic parameters are used to localize and calibrate the cameras themselves. In one embodiment, the stereo camera calibrator 125 also calibrates the offset between the stereo cameras.

The end of arm camera calibrator 127 uses the captured end of arm camera images to calibrate the end of arm camera(s).

The end of arm camera images captured by EOA camera capturer 130 are used by iterative eye-in-hand and parameter solver 135 to iteratively solve for the robot parameters and eye-in-hand transformations. The robot parameters in one embodiment are Denavit-Hartenberg (DH) parameters. These parameters and transformations are stored in memory 137 and passed to the eye-to-hand solver 145.

The eye-to-hand solver 145 uses the stereo image capture 140 data and the DH parameters to solve for the transformations for the stereo cameras. The transformations are stored in memory 147. These parameters are used by parameter based pose estimation 155.

The vision-based pose computer 150 uses the data from the image capture 130, 140 and memory 137, 147 to compute a vision-based current pose, or observed pose, for the robotic arm 192. The parameter-based pose estimator 155 uses the robot joint angles and parameters calculated by the iterative eye-in-hand and parameter solver 135 to estimate current pose for the robotic arm 192. The comparator 160 determines differences between the observation and the estimation. Based on the determined differences, a positioning error map calculator 170 calculates the positioning error map. The positioning error map is the error between where the robot thinks it is based on its kinematic model vs. where it really is, based on the system described here. In one embodiment, the positioning error map is in 6D, with each pose error value being represented. In one embodiment, the positioning error map defines errors based on the position within the working area. The calculated data is saved in memory 175 and used by the robotic system. The parameters and transformations are the calibration parameters used by the robotic system to adjust the robotic movement for accuracy when it is used.

In one embodiment, the system includes a validator/health check 180, which is used to periodically perform a validation/health check, to verify a calibration state of the system, to determine whether the robotic system needs to be recalibrated. In one embodiment, this occurs after the robotic system has been in use. The validator/health check 180 in one embodiment captures data from the static target and/or a fiducial attached to EoA tool and calculates the observed error of parameters of sensors and the robotic arm. In one embodiment, if the observed error in the parameters is above a threshold, the validator/health check 180 triggers a recalibration.

The iterative calibration system is implemented by a processing system in one embodiment. The processing system comprises one or more computing systems including one or more processors. The processing system may be a distributed system with processing occurring across multiple devices and/or processors. In one embodiment, the processing system is a local device to the robotic cell 190. In another embodiment, the processing system may include local and remote resources. Each of the elements described above may be implemented locally or remotely, or a mix of both.

By utilizing a combination of iterative solving of robot and eye-in-hand calibration and eye-to-hand calculation, the system calibrates itself for high positioning accuracy within the entire robot space and is further fine-compensated in working volumes where a specific task (e.g. pick and place) is performed.

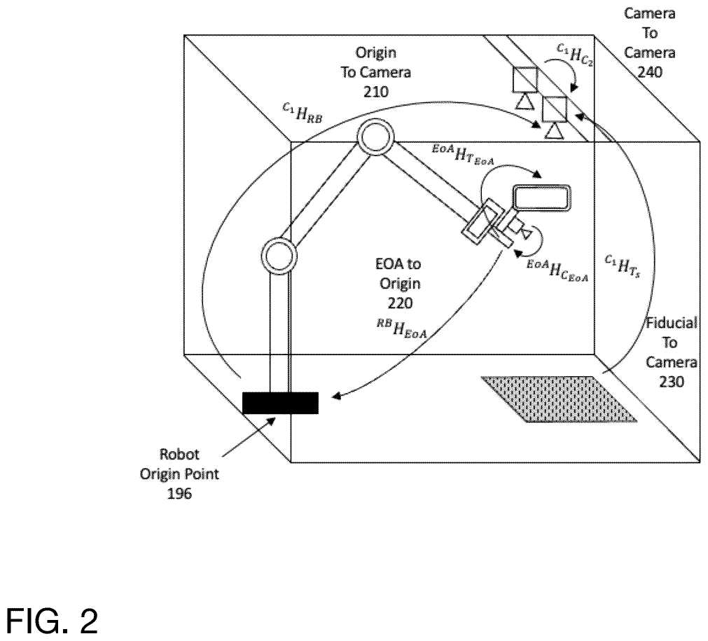

FIG. 2 is a diagram of one embodiment of a robotic arm, showing the coordinate frames. The coordinate frame is calculated from the robot origin point 196 in one embodiment. The coordinates in one embodiment include the origin to camera 210 (C1-RB), end of arm to origin 220 (RB-EOA), camera to camera 240 (C1-C2) between the stereo cameras, stationary fiducial to camera 230 (C1-Ts), end of arm to end of arm fiducial (EoA-TEoA) and end of arm to end of arm camera (EOA-CEOA).

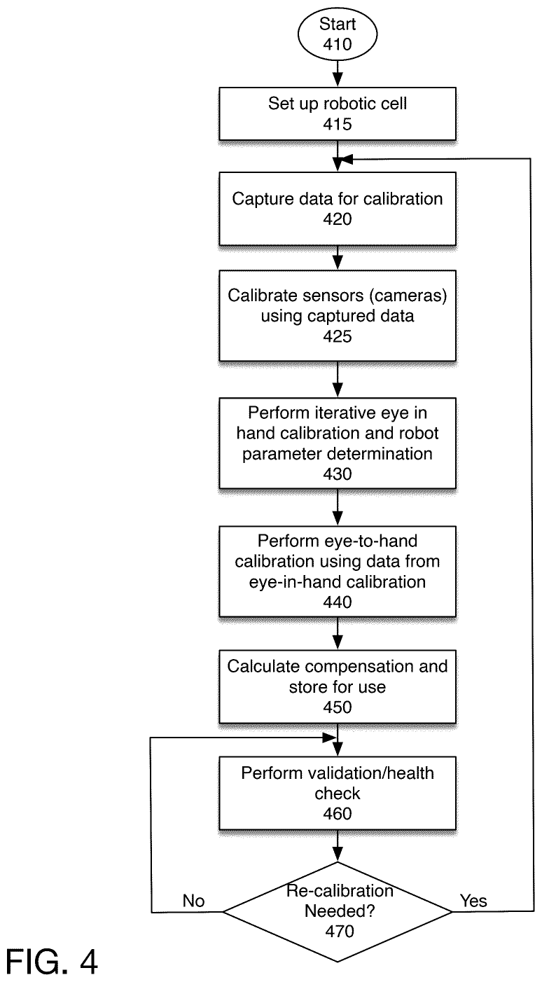

FIG. 4 is an overview flowchart of the calibration process.

The process starts at block 410. At block 415, the robotic cell is initially set up. In one embodiment, this includes installing a robotic arm, a computer system including a processing unit to provide computing power and attaching sensors to the robotic cell. In one embodiment, sensors are attached to a framework of the robotic cell, as well as the end of arm tool. In one embodiment, the sensors are two-dimensional cameras. In another embodiment, different types of sensors, e.g. 3D sensors or other sensors can be used. Depending on type of sensor, appropriate calibration board (2D or 3D) is used to calibrate sensor and robot.

After hardware set up, at block 420, a dataset for calibration process is captured. The dataset contains two sets of data; data from static sensors capturing a calibration board attached to end of arm tool and data from sensor(s) attached to end of arm tool capturing data from a static calibration board.

At block 425, the cameras and/or sensors are calibrated for their intrinsic parameters, based on the captured images. The cameras in one embodiment are also calibrated for the extrinsic relative transformation between cameras attached to the robotic cell. These parameters are calibrated independently from the robot positioning error. Once this calibration is completed, the system has the extrinsic parameters of the cameras—location and orientation—and the intrinsic parameters—focal length, principal point, distortion parameters and the derived intrinsic matrix of the camera, which maps the 3D points in camera frame to the image coordinates. The intrinsic calibration of other types of sensors may be similarly completed.

Once the static and EoA sensors are calibrated and calibration metrics (e.g. reprojection error) are within the acceptable range, the system can assume that cameras are well-calibrated using accurate calibration boards and appropriate sensor model to achieve the required accuracy. This enables the hand-eye and robot calibration.

At block 430, iterative eye-in-hand calibration and robotic parameter derivation is performed. This iterative process uses the data captured by the end of arm camera looking at a static target/fiducial (eye-in-hand). The robotic parameters, in one embodiment, are DH parameters. The system iteratively calculates the eye-in-hand calibration and the robotic parameters, until they converge. The resulting parameters are saved.

At block 440, the eye-to-hand calibration is performed, using the updated robot parameters from the iterative calibration step. The eye-to-hand calibration uses data captured by the static cameras looking at a moving target/fiducial.

At block 450, the compensation for the robotic movement is calculated based on the eye-in-hand and eye-to hand parameters and stored. This compensation is used to adjust the movements of the robot, for higher accuracy. In one embodiment, the compensation is a mapping across working volumes. The mapping is a regression between input (volume) and output (desired compensation). The system may use different regression models with different complexity. In one embodiment, a Linear Regression Model is used. In another embodiment, a Multi-Layer Perceptron (MLP) Neural Network is used to train and regress the desired compensation within the working volume.

At block 460, the process performs a validation/health check, to determine whether the robotic system needs to be recalibrated. In one embodiment, this occurs after the robotic system has been in use. Robotic systems can be used for assembling or disassembling parts, including assembling motherboards, graphics processing units, or other high value systems. Validation/health check in one embodiment comprises capturing data from the static target as well as a fiducial attached to EoA tool and calculating the observed error of parameters of sensors and the robotic arm. In one embodiment, if the observed error in the parameters is above a threshold, the validation/health check fails.

At block 470, the system determines whether the error is above a threshold, indicating that the validation/health check has failed, and recalibration is needed. In one embodiment, the system also determines the type of recalibration that should be used, based on the result of the validation health check. In one embodiment, the system determines whether full cell calibration, camera calibration, and/or robot calibration should be initiated. The selection of the type of calibration needed is based on a magnitude and location of the error, in one embodiment. For example, if the robot error is high, but stereo camera error is low, then in one embodiment, only of the system would need to be recalibrated.

If no recalibration is needed, the process continues to monitor the robotic cell as it is used, with periodic validation/health checks, at block 460. In one embodiment, the validation may occur periodically. In one embodiment, at shift or process change, the validation may be automatically initiated. In one embodiment, the validation may be initiated daily, weekly, or at some other interval. In one embodiment, the validation may be triggered based on data from a movement sensor, where the movement sensor detects a movement or shifting of the physical robotic cell. Such movement may be caused by external forces; someone bumping into the robotic cell, an earthquake, something large being dropped nearby, or another trigger that may cause the cameras or the robotic arm to come out of alignment.

If recalibration is needed as determined at block 470, the process returns to block 420, to capture data for calibration. In one embodiment, the robotic system is additionally recalibrated when it is reset to factory settings, reconfigured for a different process, or the robotic cell has gone through an accident that changed the internal parameters of the robotic cell. In one embodiment, the robotic system is recalibrated when an error level above a threshold is detected during validation. In one embodiment, the robotic system is periodically recalibrated, regardless of the results of the validation/health check. In one embodiment, recalibration may instead, or additionally, be triggered by a user.

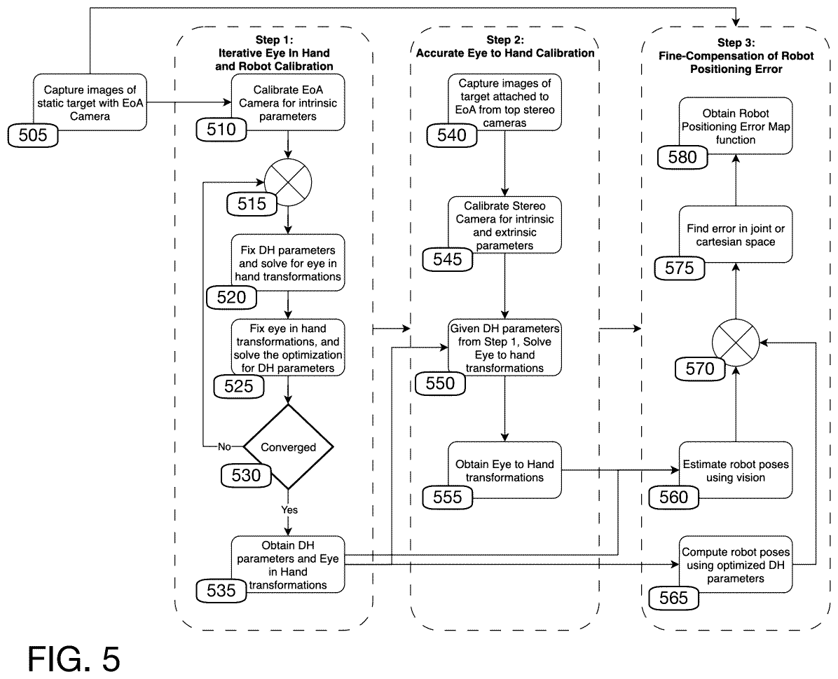

FIG. 5 is a flowchart of one embodiment of the iterative calibration system. In one embodiment, this corresponds to blocks 430, 440, and 450 of FIG. 4.

The images of a static target are captured with an end of arm camera, at block 505. The first stage calibration is the iterative eye-in-hand and robot calibration. Initially the end of arm camera is calibrated for intrinsic parameters, at block 510. The robot parameters (in one embodiment, DH parameters) are initially fixed, and the system solves for the eye-in-hand transformations, at block 520.

Next, the robot parameters are optimized using eye-in-hand transformation (block 525) and this process is iterated until convergence (Step 1). Once robot parameters are optimized, eye-to-hand calibration is performed and the transformation between robot and stereo camera pair is obtained (Step 2). Finally, the robot pose is fine-compensated by combining eye-in-hand and eye-to-hand transformations (Step 3). The resulting positioning error map function is used to adjust the robot movements for accuracy. Thus, this process provides a vision-based iterative robot calibration.

### Hand-Eye Calibration:

Hand-eye calibration can be formed in two forms,
1) Ax=yB This is the direct formation of the hand-eye calibration where two transformations (x, and y) need to be found simultaneously.
2) Ax=xB This formulation is achieved by writing the direct formulation at two different instants while the robot is moved in a non-planar motion. As a result, this formulation can only solve for one of the unknowns (transformation between robot and world in eye-to-hand and transformation between camera and EoA in eye-in-hand setup).

In one embodiment, the system uses the first formulation to compute both transformations. The direct formulation for eye-to-hand and eye-in-hand are as follows:

Eye-to-Hand (Static Camera Looking at Target Te that is Attached to EoA):

$${}^{w} {H}_{Te} \times {}^{Te} {H}_{ε} = {}^{w} {H}_{B} \times {}^{B} {H}_{ε} \qquad ( Eq . 1 )$$

which can be decomposed into rotational and translational parts:

$${}^{w} {R}_{Te} \times {}^{Te} {R}_{ε} = {}^{w} {R}_{B} \times {}^{B} {R}_{ε} \qquad ( Eq . 2 )$$

$${}^{w} {R}_{Te} \times {}^{Te} {t}_{ε} + {}^{w} {t}_{Te} = {}^{w} {R}_{B} \times {}^{B} {t}_{ε} + {}^{w} {t}_{B}$$

Eye-in-Hand (camera attached to EoA looking at static target Ts):

$${}^{B} {H}_{Ts} \times {}^{Ts} {H}_{Ce} = {}^{B} {H}_{ε} \times {}^{ε} {H}_{Ce} \qquad ( Eq . 3 )$$

which can be decomposed into rotational and translational parts:

$${}^{B} {R}_{Ts} \times {}^{Ts} {R}_{Ce} = {}^{B} {R}_{ε} \times {}^{ε} {R}_{Ce} \qquad ( Eq . 4 )$$

$${}^{B} {R}_{Ts} \times {}^{Ts} {t}_{Ce} + {}^{B} {t}_{Ts} = {}^{B} {R}_{ε} \times {}^{ε} {t}_{Ce} + {}^{B} {t}_{ε}$$

Te, Ts are End of Arm (e) and static(s) calibration boards,
w is the world frame attached to one of the stereo camera pair,
ε is the EoA frame,
B is the robot base frame,
Ce is the EoA camera frame.

The transformation ^{RB}H_{ε} (transformation between robot base and end of arm) can be found by forward kinematics of the robot (a function of robot parameters and joint angles). As a result, any error in robot parameters or joint angles readings would affect this transformation which is used to solve for hand-eye calibration problems. The two equations above can be formed as follow:

$${}^{w} {H}_{Te} \times {}^{Te} {H}_{ε} = {}^{w} {H}_{B} \times f ( κ + {ϵ}_{κ} , θ + {ϵ}_{θ} ) \qquad ( Eq . 5 )$$

$${}^{B} {H}_{Ts} \times {}^{Ts} {H}_{Ce} = f ( κ + {ϵ}_{κ} , θ + {ϵ}_{θ} ) \times {}^{ε} {H}_{Ce}$$

here κ, and θ are nominal robot parameters and joint angles respectively.

### Iterative Robot-Vision Calibration

The present system in one embodiment uses a combined Eye-to-Hand and Eye-in-Hand configuration to accurately correct for robot positioning error in three steps:
1. Iterative Eye-in-Hand and robot calibration:
2. Eye-to-hand calibration
3. Fine-Compensation of Robot Positioning Error

### Iterative Eye-in-Hand Calibration:

Given a calibrated EoA camera with known intrinsic parameters, the pose of static calibration board in camera frame (^{TS}H_{Ce}) can be computed using Perspective from N Point (PnP) algorithm for 2D sensors or 3D registration algorithms like iterative closest point (ICP) for 3D sensors. Given robot parameters (DH table) and joint angles, the pose of EoA in robot frame can be found using forward kinematics. In one embodiment, the system iteratively solves for parameters of DH table and eye-in-hand transformations:
1. Fix robot kinematic parameters, solve for Eye-in-Hand calibration until convergence (block 520): This is normal eye-in-hand calibration as formulated in Eq. 3 and 4 and has been widely studied in the literature.
2. Fix Eye-in-Hand transformation, and optimize for robot kinematic parameters (block 525): Eq. 6 can be written as:

$$f ( κ + {ϵ}_{κ} , θ + {ϵ}_{θ} ) = {}^{B} {H}_{w} \times {}^{w} {H}_{Ts} \times {}^{Ts} {H}_{Ce} \times {}^{Ce} {H}_{ε} \qquad ( Eq . 6 )$$

All the transformations on the right side of the equation are known.

The robot kinematic model (initially formulated as Denavit-Hartenberg and known as DH parameters) is obtained by chaining transformations along the joints of manipulator.

In one embodiment, the robot's kinematics can be expressed as Modified Complete and Parametrically Continuous (MCPC) model which is a parametrically continuous and complete model. The MCPC model assumes all joints to move along their z axes while connecting two joints Jᵢ and Jᵢ₊₁ by rotating the frame Jᵢ around its x and y axis to align its xy-plane with the xy-plane of Jᵢ₊₁ and translating it along the new x and y axes to position the new origin on the z-axis of Jᵢ₊₁. The MCPC model decomposes f as the product of alternating transformations along static segments and joints. Solving this equation requires a non-linear optimization that starts with an initial guess and computes gradients of error with respect to robot kinematic parameters and iterates until convergence.

Iterate between eye-in-hand and robot calibrations (block 530): since on each iteration the computed parameters from previous step are used, one convergence criterion is for parameters to have small changes. If the parameters from previous step do not change, the outcome of the iteration will be close to the previous step, and the optimization can be stopped. Another criterion is to compute the error between vision estimated and robot reported position and continue until the error becomes smaller than a threshold. In one embodiment, the threshold for such difference is less than 50 microns. If it has not yet converged, the process returns (block 515) to reiterate the calculation.

Once the convergence is achieved, the DH parameters and eye-in-hand transformations are obtained from the calculations, at block 535. In one embodiment, this data is saved and used by the system in calculating the fine compensation, described below.

### Eye-to-Hand Calibration (Cell Calibration)

The images of the target attached to the end of arm are captured (block 540) and used to calibrate the stereo cameras attached to the robotic cell frame, for intrinsic and extrinsic parameters (block 545). This may occur concurrently with the calibration of the EoA camera, or at a different time. In one embodiment, the system can use Perspective from N Point (PnP) algorithm for 2D sensors or 3D registration algorithms like iterative closest point (ICP) for 3D sensors.

Using the optimized kinematics parameters from previous step, the corrected pose of EoA is estimated and used for eye-to-hand calibration and the transformation between stereo pair and robot base is found (block 550).

The eye-to-hand transformations are obtained (block 555) and stored in memory in one embodiment. These transformations are used by the system in calculating the fine compensation, described below.

### Fine-Compensation of Robot Positioning Error

Since joint angle readings can be prone to error, in one embodiment the system sets up a final error compensation using vision system (top stereo cameras together with EoA camera) to create a mapping from pose of EoA (or joint angles) to compensation-deltas that correct the input within the working volume.

The robot pose may be computed using the optimized parameters derived in the Iterative Eye-in-Hand Calibration (block 565).

The pose of a large target can be accurately found both by static stereo camera pairs as well as EoA camera, and thus the pose of EoA in robot base frame can be estimated using calibrated vision system (block 560).

$$\{ \begin{matrix}Estimated by vision : {}^{B} {H}_{ε} = {}^{B} {H}_{w} \times {}^{w} {H}_{Ts} \times {}^{Ts} {H}_{{C}_{e}} \times {}^{{C}_{e}} {H}_{ε} \\ Reported by forward kinematics : {}^{B} {H}_{ε} = f ( κ + {ϵ}_{κ} , ϑ + {ϵ}_{ϑ} )\end{matrix} \qquad ( Eq . 7 )$$

The estimation and computation can be compared (block 570) to identify errors. The error is found based on the difference between the vision estimated and reported poses in joint and/or cartesian space (block 575).

Given a set of input output correspondences, the robot positioning error map function is derived (block 580). The error map function in one embodiment is a 6 dimensional function, with each pose error value being represented. The mapping function can be obtained through various methods e.g. using a neural network, K-nearest neighbor algorithm, linear grid-based interpolation, non-linear interpolation, non-linear regression models, etc. In one embodiment, the K-nearest neighbor algorithm is used. The mapping is across working volumes. In one embodiment, the mapping is a regression between input (volume) and output (desired compensation).

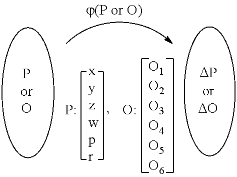

The calculated robot positioning error map function is used to adjust the movement of the robot during use. The movement of the robotic arm is adjusted during use, based on the positioning error map function. Thus, the present system provides an improved calibration to obtain an accurate error map which is used to adjust the movement of the robot to improve accuracy.

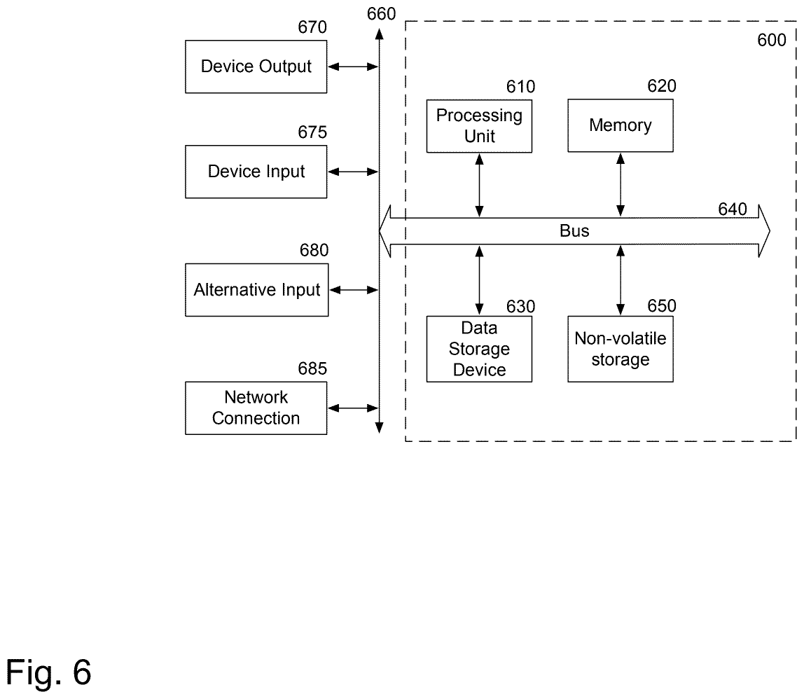

FIG. 6 is a block diagram of one embodiment of a specific purpose computer system which may be part of the processing system. It will be apparent to those of ordinary skill in the art, however that other alternative systems of various system architectures may also be used.

The computer system illustrated in FIG. 6 includes a bus or other internal communication means 640 for communicating information, and a processing unit 610 coupled to the bus 640 for processing information. The processing unit 610 may be a central processing unit (CPU), a digital signal processor (DSP), graphics processor (GPU), or another type of processing unit 610.

The system further includes, in one embodiment, a memory 620, which may be a random access memory (RAM) or other storage device 620, coupled to bus 640 for storing information and instructions to be executed by processor 610. Memory 620 may also be used for storing temporary variables or other intermediate information during execution of instructions by processing unit 610.

The system also comprises in one embodiment a read only memory (ROM) 650 and/or static storage device 650 coupled to bus 640 for storing static information and instructions for processor 610.

In one embodiment, the system also includes a data storage device 630 such as a magnetic disk or optical disk and its corresponding disk drive, or Flash memory or other storage which is capable of storing data when no power is supplied to the system. Data storage device 630 in one embodiment is coupled to bus 640 for storing information and instructions.

In some embodiments, the system may further be coupled to an output device 670, such as a computer screen, speaker, or other output mechanism coupled to bus 640 through bus 660 for outputting information. The output device 670 may be a visual output device, an audio output device, and/or tactile output device (e.g., vibrations, etc.)

An input device 675 may be coupled to the bus 660. The input device 675 may be an alphanumeric input device, such as a keyboard including alphanumeric and other keys, for enabling a user to communicate information and command selections to processing unit 610. An additional user input device 680 may further be included. One such user input device 680 is cursor control device 680, such as a mouse, a trackball, stylus, cursor direction keys, or touch screen, may be coupled to bus 640 through bus 660 for communicating direction information and command selections to processing unit 610, and for controlling movement on display device 670.

Another device, which may optionally be coupled to computer system 600, is a network device 685 for accessing other nodes of a distributed system via a network. The communication device 685 may include any of a number of commercially available networking peripheral devices such as those used for coupling to an Ethernet, token ring, Internet, or wide area network, personal area network, wireless network, or other method of accessing other devices. The communication device 685 may further be a null-modem connection, or any other mechanism that provides connectivity between the computer system 600 and the outside world.

Note that any or all of the components of this system illustrated in FIG. 6 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 620, mass storage device 630, or other storage medium locally or remotely accessible to processor 610.

It will be apparent to those of ordinary skill in the art that the system, method, and process described herein can be implemented as software stored in main memory 620 or read only memory 650 and executed by processor 610. This control logic or software may also be resident on an article of manufacture comprising a computer readable medium having computer readable program code embodied therein and being readable by the mass storage device 630 and for causing the processor 610 to operate in accordance with the methods and teachings herein.

The computer system 600 may be used to program and configure the robotic cells and provide instructions to the robotic arm. The computer system 600 is also part of each robotic cell, enabling the robotic cell to execute instructions received in a recipe. The robotic cell is a special purpose appliance including a subset of the computer hardware components described above. For example, the appliance may include a processing unit 610, a data storage device 630, a bus 640, and memory 620, and no input/output mechanisms, except for a network connection to receive the instructions for execution. In general, the more special purpose the device is, the fewer of the elements need be present for the device to function. In some devices, communications with the user may be through a touch-based screen, or similar mechanism. In one embodiment, the device may not provide any direct input/output signals but may be configured and accessed through a website or other network-based connection through network device 685.

It will be appreciated by those of ordinary skill in the art that any configuration of the particular machine implemented as the computer system may be used according to the particular implementation. The control logic or software implementing the present invention can be stored on a machine-readable medium locally or remotely accessible to processor 610. A machine-readable medium includes any mechanism for storing information in a form readable by a machine (e.g., a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical, or other forms of propagated signals (e.g., carrier waves, infrared signals, digital signals, etc.).

Furthermore, the present system may be implemented on a distributed computing system, in one embodiment. In a distributed computing system, the processing may take place on one or more remote computer systems from the location of an operator. The system may provide local processing using a computer system 600, and further utilize one or more remote systems for storage and/or processing. In one embodiment, the present system may further utilize distributed computers. In one embodiment, the computer system 600 may represent a client and/or server computer on which software is executed. Other configurations of the processing system executing the processes described herein may be utilized without departing from the scope of the disclosure.

In the foregoing specification, the present system has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative rather than a restrictive sense.

We claim:

1. A method of calibrating a robotic arm comprising:
perform iterative eye-in-hand and robot calibration, using a calibrated end of arm camera with known intrinsic parameters and a static target, to obtain eye-in-hand transformations and robotic parameters;
use robotic parameters to estimate pose of end of arm, for eye-to-hand calibration, to obtain eye-to-hand transformations;
calculate final error compensation based on the robotic parameters, eye-to-hand transformations, and eye-in-hand transformations; and
calculate a robot positioning error map function, the robot positioning error map function used to adjust movement parameters for the robotic arm.

2. The method of claim 1, wherein the iterative eye-in-hand and robot calibration comprises:
fixing robotic parameters and solving for eye-in-hand transformations;
fixing eye-in-hand transformations, and solving for the robotic parameters; and
determining when the robotic parameters and the eye-in-hand transformations have converged.

3. The method of claim 2, wherein the robotic parameters comprise Denavit-Hartenberg (DH) parameters.

4. The method of claim 1, wherein calculating the final error compensation comprises:
computing a robotic pose using the robotic parameters;
estimating the robotic pose using vision based on the eye-to-hand transformations and the eye-in-hand transformations; and
comparing the computed pose and the estimated pose to identify errors.

5. The method of claim 4, wherein the errors are identified in joint space.

6. The method of claim 4, wherein the errors are identified in Cartesian space.

7. The method of claim 1, wherein calculating the robot positioning error map function utilizes one or more of: a neural network, k-nearest neighbor algorithm, linear grid-based interpolation, or non-linear grid-base interpolation.

8. The method of claim 1, further comprising:
validating the robot and sensor calibration by comparing the pose from a validation image to the estimated pose and determining whether the robotic arm and/or cell should be recalibrated.

9. The method of claim 8, wherein the validating is triggered periodically.

10. The method of claim 8, wherein the validating is triggered when a movement of the robotic cell above a threshold is detected.

11. The method of claim 8, further comprising:
triggering a recalibration when validation metrics indicates that a difference between the calculated pose and the validation pose is above a threshold.

12. An iterative calibration system for calibrating a robotic arm comprising:
a processing system configured to perform iterative eye-in-hand and robot calibration, using a calibrated end of arm camera with known intrinsic parameters and a static target, to obtain eye-in-hand transformations and robotic parameters;
the processing system further configured to use robotic parameters to estimate a pose of the calibrated end of arm, for eye-to-hand calibration, to obtain eye-to-hand transformations;
the processing system further to calculate final error compensation based on the robotic parameters, eye-to-hand transformations, and eye-in-hand transformations; and
the processing system further to calculate a robot positioning error map function, the robot positioning error map function used to adjust movement parameters for the robotic arm.

13. The system of claim 12, wherein the processing system implements an iterative eye-in-hand and parameter solving configured to fix robotic parameters and solving for eye-in-hand transformations, fix eye-in-hand transformations, and solving for the robotic parameters, and determine when the robotic parameters and the eye-in-hand transformations have converged.

14. The system of claim 13, wherein the robotic parameters comprise Denavit-Hartenberg (DH) parameters.

15. The system of claim 12, wherein the processing system implements a positioning error map calculation configured to calculate the final error compensation, the system comprising:
a parameter-based pose estimation configured to compute a robotic pose using the robotic parameters;
a vision-based pose computation configured to estimate the robotic pose using vision based on the eye-to-hand transformations and the eye-in-hand transformations; and
a comparator configured to compare the computed pose and the estimated pose to identify errors.

16. The system of claim 15, wherein the errors are identified in one of joint space and Cartesian space.

17. The system of claim 12, further comprising:
one or more of: a neural network, k-nearest neighbor algorithm, linear grid-based interpolation, or non-linear grid-base interpolation.

18. The system of claim 12, further comprising:
a validator configured to verify a calibration state by comparing the pose from a validation image to the estimated pose and determine whether the robotic arm and/or cell should be recalibrated.

19. The system of claim 18, wherein the validator is triggered one of:
periodically, upon detection a movement of the robotic cell above a threshold, when validation metrics indicates that a difference between the calculated pose and the validation pose is above a threshold.

20. A robotic cell comprising:
a robotic arm;
an end of arm;
a static sensor coupled to the robotic cell;
a calibrated end of arm sensor coupled to the end of arm; and
an iterative calibration system comprising:
an iterative eye-in-hand and parameter solver configured to perform iterative eye-in-hand and robot calibration, using the calibrated end of arm sensor with known intrinsic parameters and a static target, to obtain eye-in-hand transformations and robotic parameters;
a parameter-based pose estimation configured to use robotic parameters to estimate pose of end of arm, for eye-to-hand calibration, to obtain eye-to-hand transformations;
a comparator to calculate final error compensation based on the robotic parameters, eye-to-hand transformations, and eye-in-hand transformations; and
position error map calculator configured to calculate a robot positioning error map function to adjust movement parameters for the robotic arm.
